(19) United States
(12) Patent Application Publication
(10) Pub. No.: US 2009/0084913 A1
(43) Pub. Date: Apr. 2, 2009

(54) AUTOMATED MOUNTING ARM FOR ELECTRONIC DISPLAY

(76) Inventors: Bogdan Grabania, Savage, MN (US); Kamil Sienkiel, Savage, MN (US); Greg Rupp, Belle Plain, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 12/113,013

(22) Filed: Apr. 30, 2008

(30) Foreign Application Priority Data
Apr. 30, 2007 (PL) P 382 326
Apr. 30, 2007 (PL) P382 327
Mar. 14, 2008 (PL) P 384 694

(51) Int. Cl. F16M 11/04; F16M 11/16; F16M 11/00

(52) U.S. Cl. 248/176.3; 248/276.1; 248/694

(57) ABSTRACT

An automated single or dual arm articulating mount assembly for flat panel displays. In a dual arm system, a first motorized drive system enables synchronous movement of the pantograph to allow for extension movement of the display to and from the mounting surface. In a single arm system, the motorized drive system causes extension movement similar to the dual arm system. A second motorized drive system can be positioned on the display interface area for rotational movement of the screen about a vertical axis.

### RELATED APPLICATIONS

This application claims priority to Polish Application Nos. P 382 326, and P382 327, both filed Apr. 30, 2007, as well as P 384 694, filed Mar. 14, 2008, all of which are incorporated herein by reference.

### FIELD OF THE INVENTION

The invention generally relates to a mounting arm for an electronic display. More particularly, the invention relates to a motor-driven, remote-controlled articulating arm for an electronic display, such as a flat panel television.

### BACKGROUND OF THE INVENTION

Flat panel electronic displays, such as LCD and plasma televisions, have become an increasingly popular substitute because of their improved picture, space saving characteristics, and the relative ease of moving such electronic displays as compared to traditional cathode ray tube (CRT) televisions. Furthermore, because of their light weight designs, flat panel displays provide more display and mounting options than CRT televisions. Flat panel displays are typically mounted to a structure, such as a wall. One popular wall mounting system is an articulating arm mount in which either a single or dual arm mount allows for horizontal extension from the wall or other fixed mounting surface, horizontal arced movement of the flat panel display, vertical displacement of the display with respect to the fixed mounting support, and tilt movement of the display itself in multiple planes in the vertical axis with respect to the articulating arm.

One particular articulating arm mounting system is described in U.S. Pat. No. 6,905,101, entitled “Adjustable, Self-Balancing Flat Panel Display Mounting System” to Dittmer, incorporated herein, in its entirety, by reference. The flat screen mounting system of the '101 patent includes two joined mounting elements, one of which is a wall mounting support fastened to a stable, fixed mounting surface, such as a wall, while the flat screen is mounted to the other mounting element which is a mounting panel. One of the two joined mounting elements has a guide or slide, along which the mounted screen moves or revolves in an arc with regard to a horizontal screen rotation axis. The screen rotation axis is placed near the screen's center of gravity. The mounting panel of the screen is joined and fastened to the wall mounting support with a dual arm system made up of front and rear arms, joined with hinges forming a parallelogram capable of parallel movement. The mounting system is moved manually by hand in all planes.

There remains a need for an automated flat screen mounting system that can be automatically adjusted in a full range of motion.

### SUMMARY OF THE INVENTION

The automated mounting assemblies for flat panel displays of the present invention include a single arm and a dual arm mounting assembly that incorporates one or more driving motors for automatic movement of the mounting assembly in all directions or planes. The automatic movement can be controlled by means of an infrared or radio frequency remote control system.

In one embodiment of the invention, a single arm mount for mounting a flat panel display, particularly a flat panel television, includes a rotating arm mounted to a fixed mounting surface. The rotating arm includes a rear arm and hinge-connected front arm. The flat panel display is mounted on an end of the front arm opposite an end that is hinge-connected to an end of the rear arm. An end of the rear arm opposite the end that is hinge-connected to the rear arm is fastened to the mounting surface. The single arm mount has a first motor drive system which enables selective movement of the flat panel with respect a horizontal axis, and a second motor drive system for selective display screen rotation about a vertical axis. The single arm mount further includes a pair of guides, one of which is mounted in parallel to the front arm, and one that is mounted in parallel to the rear arm. A synchronization system of the single arm mount includes two fittings, each connected on one end to either the front arm or the rear arm, and the other end rotatably coupled to each other and to a mandrel. The mandrel is slidingly mounted to a central yoke on which is mounted an end of each guide, an end of the front arm, and an end of the rear arm.

An extension motion, i.e. translation along the horizontal axis is accomplished by a driving system including a motor for actuating rotation of the rear arm about a vertical axis, which in turn, actuates rotation of the front arm about a second vertical axis such that a display interface extends to and from the mounting surface. A second drive system can be included on the display interface for display rotation about a third vertical axis.

In another embodiment of the invention, a dual arm mount for mounting a flat panel display, particularly a flat panel television, includes a first and second rotating arm mounted to a fixed mounting surface, forming a pantograph. Each rotating arm includes a rear arm and hinge-connected front arm. The flat panel display is mounted on an end of the front arm opposite an end that is hinge-connected to an end of the rear arm. An end of the rear arm opposite the end that is hinge-connected to the rear arm is fastened to the mounting surface.

A drive system includes a motor, a driving element for each arm, and a driving segment for each arm. A shaft of the motor is operably coupled to the driving element, which is operably coupled to the driving segment of each arm, such that when the motor is actuated, the driving element and driving segments are driven, ultimately driving rotation of each rear arm. The rotation of each rear arm correspondingly rotates a coupled front arm, such that translation along a horizontal plane of the display surface is achieved. A second drive system can be included on the display interface for display rotation about a vertical axis.

The above summary of the invention is not intended to describe each illustrated embodiment or every implementation of the present invention. The figures and the detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is a bottom view depicting a motor-drive system of a single-arm mount according to an embodiment of the invention;

FIG. 2 is a side view depicting a stabilization assembly of a single-arm mount according to an embodiment of the invention;

FIG. 3 is a bottom view depicting a motor-drive system of a dual-arm mount according to an embodiment of the invention;

FIG. 4 is bottom view depicting a drive assembly of a dual-arm mount according to an embodiment of the invention;

FIG. 5 is a side view depicting the drive assembly of FIG. 4;

FIG. 6 is a bottom view depicting a drive assembly of a dual-arm mount according to an embodiment of the invention;

FIG. 7 is a top view depicting an arm synchronicity unit for a dual-arm mount according to an embodiment of the invention;

FIG. 8 is a side view depicting the arm synchronicity unit of FIG. 7;

FIG. 9 is a perspective view depicting a dual-arm mount with uprights according to an embodiment of the invention;

FIG. 10 is a bottom view depicting a drive assembly of the dual-arm mount according to FIG. 9;

FIG. 11 is a front view depicting a dual-arm mount with uprights according to an embodiment of the invention;

FIG. 12 is a fragmentary perspective view depicting a drive assembly of a dual-arm mount according to an embodiment of the invention; and

FIG. 13 is a fragmentary perspective view of the drive assembly of FIG. 12 depicting the housing of the drive assembly in phantom.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE DRAWINGS

Embodiments of the present invention generally include an automated mounting arm assembly, having either a single articulating arm, or a dual-arm pantograph assembly. The mounting arm assembly accommodates automated movement of the flat panel along a plane substantially perpendicular to the plane of a mounting surface by incorporation of a motorized drive system. Further, rotation of the display screen about an axis substantially parallel to the mounting surface can be accomplished via a second motorized drive system mounted to a screen interface.

The figures designate, for reference purposes, the relative directions of x-y-z coordinates as applied to the mounting arm assembly. Any reference herein to movement in an x-axis direction, a y-axis direction, or a z-axis direction relates to these coordinate axes. The z-axis is oriented up and down, substantially parallel to a mounting surface, the x-axis is fore-and aft from the mounting surface, and the y-axis is perpendicular to the z-axis and the x-axis and is oriented laterally from side-to-side of the mounting arm assembly.

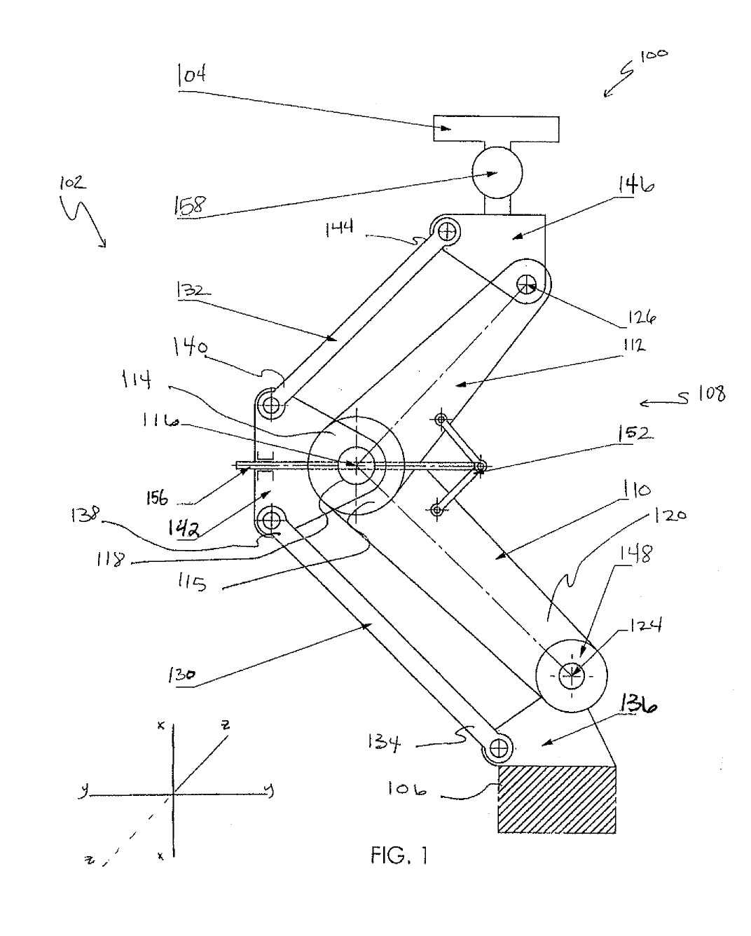

Referring to FIG. 1, in one embodiment of the invention, automated mounting arm 100 is a single-arm mounting assembly generally including a support structure 102, and a display interface 104. Support structure 102 generally includes mount interface 136 adapted to attached to a fixed structure 106 such as the wall of a structure, and an articulating arm assembly 108. In one embodiment of the invention, articulating arm assembly 108 includes a rear arm 110 and a front arm 112. A first end 114 of front arm 112 is operably and rotationally joined to a first end 122 of rear arm 110 by a hinge 118 such that rear arm 110 and front arm 112 are rotatable about a substantially vertical axis 116, parallel to the z-axis, extending through hinge 118. A second opposite end 120 of rear arm 110 is hingedly joined to a fixed mounting surface (not shown) such that rear arm 110 rotates about a substantially vertical axis 124, substantially parallel to the z-axis. A second end 128 of front arm 112 generally opposing first end 114 is hingedly joined to display interface 104 for rotation of display interface 104 about a substantially vertical axis 126, substantially parallel to the z-axis.

A first guide 130 is mounted in parallel to rear arm 110, and a second guide 132 is mounted in parallel to front arm 112. Both a first side 134 of first guide 130 and second end 120 of rear arm 110 are rotatably mounted to fixed structure 106 by a mount interface 136. A second opposing end 138 of first guide 130 and a first end 140 of second guide 132 are rotatably mounted to a central yoke 142, on which hinge 118 is also mounted, joining rear arm 110 and front arm 112. A second opposing end 144 of second guide 132 and second end 128 of front arm 112 are rotationally mounted on a front yoke 146, from which display interface 104 extends.

A motor assembly 148 is positioned on mount interface 136 at vertical axis 124 for an extension movement of arm 100 along the x-axis. In one embodiment of the invention, motor assembly 148 comprises a shaft and a system of gearwheels such that, when the gearwheels are rotating, rear arm 110 rotates about vertical axis 124 moving arm 100 in an arced path about an x-y plane to articulate arm 100 towards and away from fixed structure 106 and the mounting surface along the x-axis.

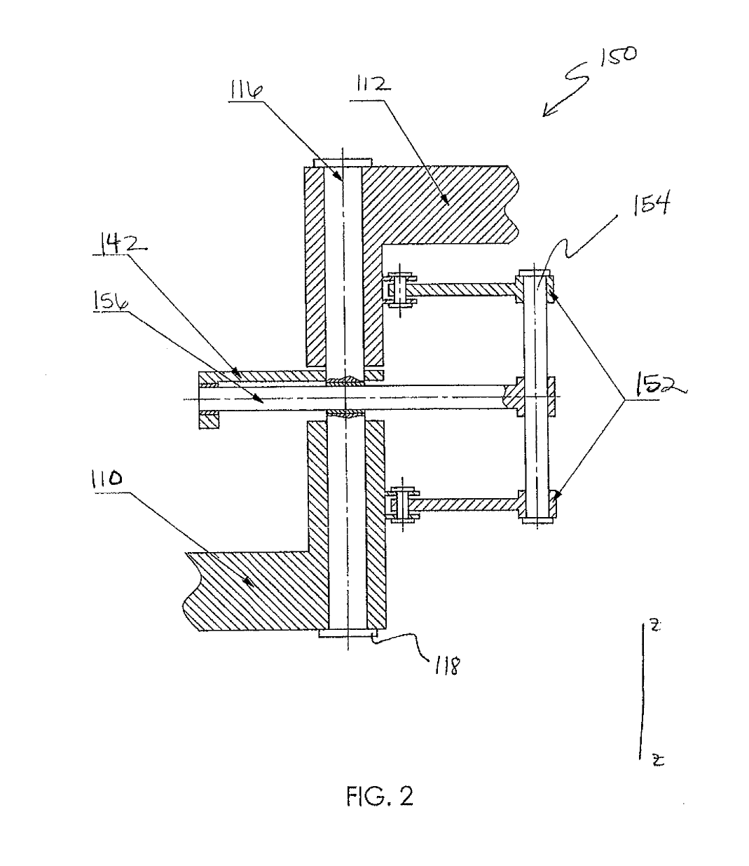

Arm 100 further has a synchronization system 150 for support structure 102 and screen interface 104. Referring to FIG. 2, synchronization system 150 generally includes two fittings 152, each fitting 152 having a first end hingedly and rotatably mounted to one of either rear arm 110 or front arm 112, and a second end rotatably mounted to a bolt 154 extending along a substantially vertical axis to connect two fittings 152. Bolt 154 operably joins each fitting 152 to mandrel 156. Mandrel 156 is slidingly mounted to central yoke 142, diametrically crossing hinge 118 and axis of rotation 1116.

The system of structures 136, 142, and 146 and guides 130 and 132 connect rear arm 110 and front arm 112 so that arm 100 moves in a single parallel, synchronized motion as rear arm 110 rotates about axis 124 to extend and retract arm 100 from fixed structure 106. For example, during extension of arm 100 from fixed structure 106, fittings 152 move aside, sliding mandrel 156 through central yoke 142 to stabilize guides 130 and 132. Mandrel 156 keeps guides 130 and 132 parallel to rear arm 110 and front arm 112 respectively. As arm 100 is extending from fixed structure 106, screen interface 104 remains substantially parallel to fixed structure 106.

In embodiments of the invention, screen interface 104 rotates about a substantially vertical axis by a motor assembly 158 mounted to front yoke 146. Motor assembly 158 can include, for example, a gearwheel mounted on a shaft of a motor (not shown), that is in toothed-cooperation with a second gearwheel, mounted on a bolt passing through a vertical axis of rotation of screen interface 104. As an output shaft of the motor rotates, the bolt rotates in response, rotating screen interface 104.

In yet other embodiments of the invention, a separate head assembly (not shown) can be used for tilting screen interface 104 from a substantially vertical plane. One example of a motorized head assembly is described in co-pending application entitled “Automated Tilt Head for Electronic Display Mount” filed on even date herewith and designated with attorney docket number 3156.264US01, said application being incorporated herein by reference in its entirety. An example of a manually adjustable head assembly is described in International Application PCT/US2008/000044, filed Jan. 3, 2004, entitled “Device Mount with Selectively Positionable Tilt Axis,” incorporated herein by reference in its entirety.

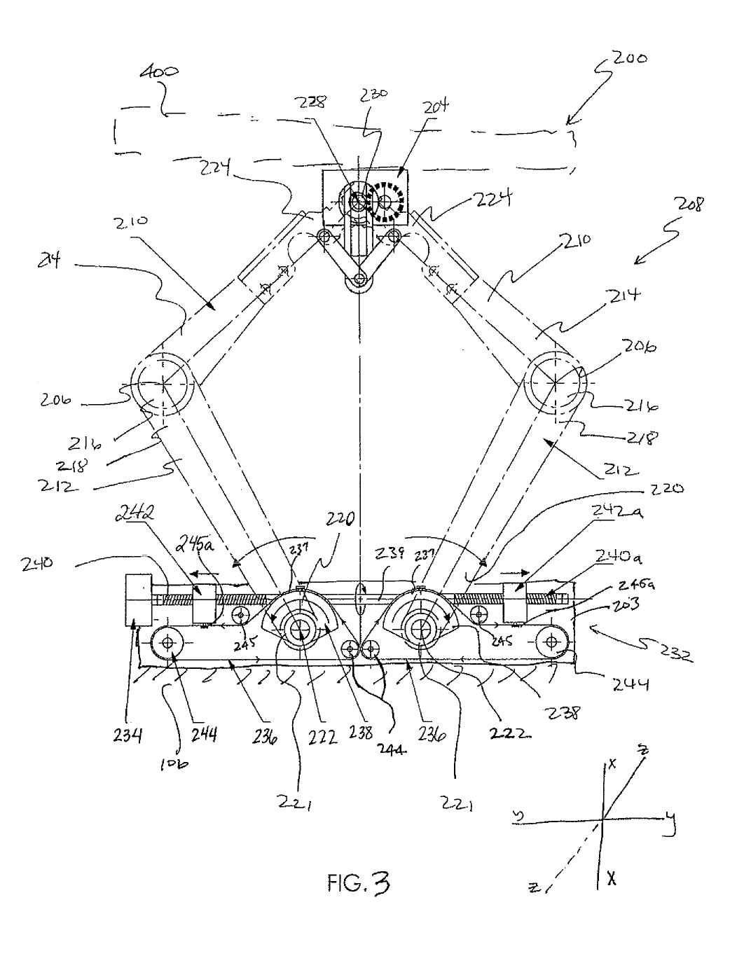

Referring to FIG. 3-8, automated mounting arm 200 is a dual-arm mounting assembly generally including a pantograph support structure 202, and a display interface 204. Support structure 202 generally includes a mounting interface 203, and an articulating arm assembly 208. In one embodiment of the invention, articulating arm assembly 208 includes dual front arms 210 and dual rear arms 212. A first end 214 of each front arm 210 is joined by a hinge 216 to a first end 218 of a rear arm 212 such that each front arm 210 and rear arm 212 are rotatable about a substantially vertical axis 206 extending through hinge 216. Front arms 210 and rear arms 212 form a parallelogram.

Each rear arm 212 is rotationally fastened to mounting area (not shown) at a second end 220 by a hinge 221 such that each arm 212 is rotatable around a substantially vertical axis 222 passing through hinge 221. A second end 224 of each front arm 210 is rotatable, hingedly mounted to display interface 204 such that front arms 210 are rotable around a single substantially vertical axis 228 passing through hinge 230.

Translating movement along an x-axis is accomplished via a driving system 232. Driving system 232 generally includes a motor 234, at least one driving element 236, and at least one driving segment 238. Motor 234 rotates a shaft, such as a screw, which in turn actuates driving elements 236, which in turn drives driving segments 238 to cause rotation of rear arms 212 around each vertical axis of rotation 222, causing extension or retraction movement of arm 200 along an x axis.

In one embodiment of the invention, referring to FIG. 3, motor 234 rotates a shaft 239 with first 240 and second 240a screws. Each screw 240, 240a, is threadedly coupled with a screw cap 242, 242a, respectively. Screws 240, 240a, are opposite-handed so that screw caps 240, 240a, translate in opposite directions along shaft 239 as shaft 239 is rotated. In embodiments of the invention, driving elements 236 may be chains, wires, belts, or other flexible coupling means. Driving elements 236 are engaged over roller elements 244, which are rotatable mounted on mounting interface 203. It will be appreciated that if driving elements 236 are chains, roller elements 244 may be cogs, or if driving elements 236 are wires or belts, roller elements 244 may be rollers, sheaves, or pulleys. Tensioning rollers 245 may be selectively translatably mounted to mounting interface 203 to provide for tensioning adjustment of driving elements 236. Each screw cap 242, 242a, is fixed to a driving element 236 with connector 245a. Each of driving elements 236 are further engaged and fixed along periphery 237 of one of driving segments 238.

In operation, as shaft 239 rotates, screw caps 242, 242a translate in opposite directions, urged by screws 240, 240a, respectively. As screw caps 242, 242a, translate, driving elements 236 are pulled over roller elements 244. Driving elements 236 being engaged with the driving segments 238 cause the driving segments 238 to each rotate in opposite directions about their respective vertical axes 222, which in turn causes rear arm 212 to rotate. Accordingly, the ends 218 of rear arms 212 are shifted generally in the x direction from the mounting surface.

More particularly, as shown in FIG. 3, as shaft 239 rotates in a clockwise direction, screw caps 242, 242a, move to the left and to the right along y-axis respectively, away from each other. This in turn causes driving elements 236 to translate in opposite directions from each other, rotating left driving segment 238 and therefore left rear arm 212 counterclockwise, and right driving segment 238 and therefore right rear arm 212 clockwise, resulting in translating movement of arm 200 along the x axis towards fixed structure 106. Rotation of shaft 239 in the opposite counter-clockwise direction would result in movement of arm 200 on the x axis away from fixed structure 106.

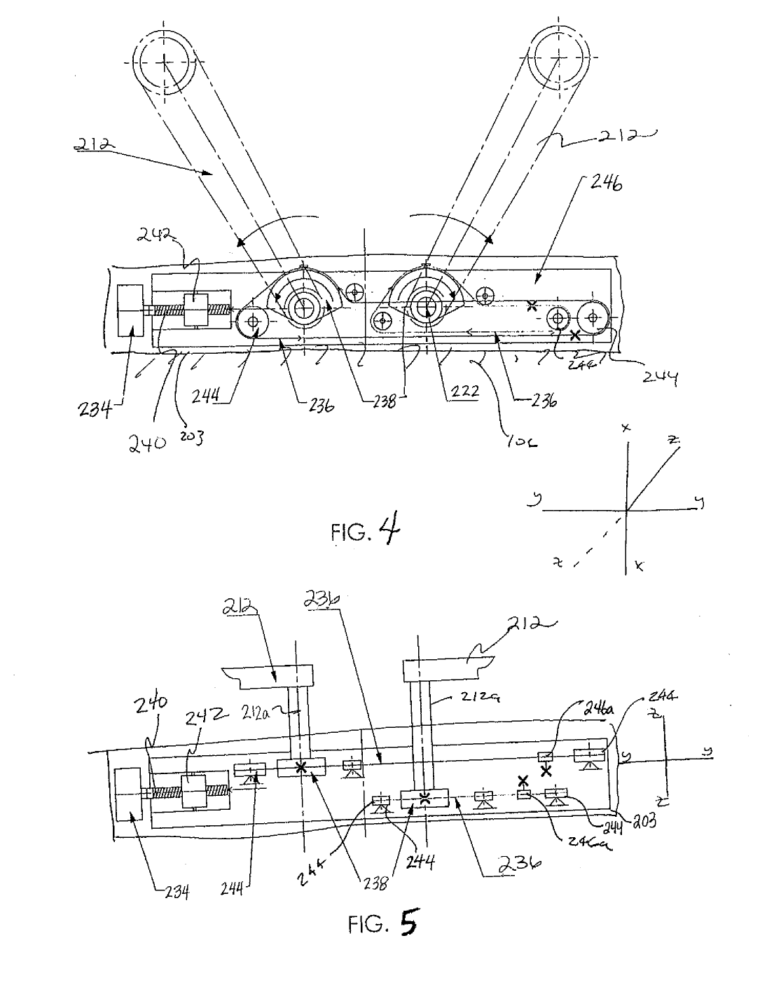

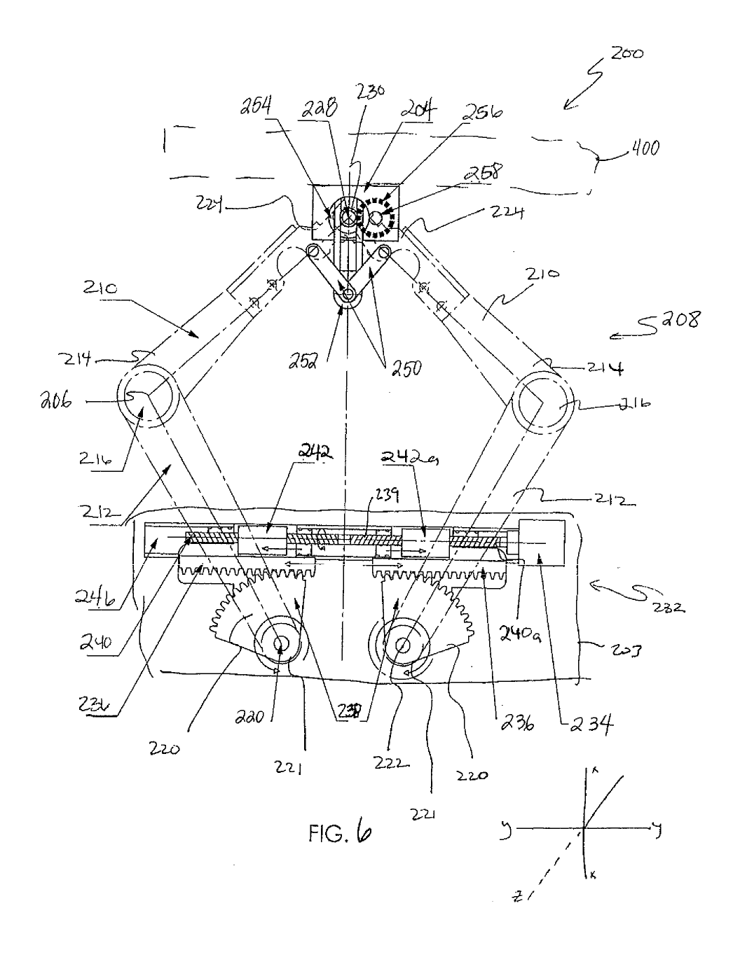

In another embodiment, as depicted in FIGS. 4 and 5, motor 234 rotates a single screw 240, which moves screw cap 242 and a driving bar 246 fixedly joined to screw cap 242. Driving elements 236, such as chains, wires, or belts are set over roller elements 244, which are rotatably mounted on bar 246. Driving elements 236 are also coupled to mounting interface 203 with couplers 246a. Arms 212 are rotatably mounted on mounting interface 203 with shafts 212a. Each driving element 236 is coupled with one of driving segments 238, which are rotatably fixed to one of shafts 212a, and which may include at least one tooth or similar element for engaging driving element 236 in the event that driving elements 236 is a chain.

As motor 234 drives screw cap 242, bar 246 is shifted laterally along the y-axis. Roller elements 244 translate with bar 246, but driving elements 236 are fixed to mounting interface 203. Accordingly, driving elements 236 roll over roller elements 244 and each of couplers 246a translates in an opposite direction relative to bar 246. The engagement of driving elements 236 with driving segments 238 cause driving segments 238 to rotate in opposite directions about its axis 222, which in turn causes rear arm 212 to extend or retract in the x direction from the mounting surface. Thus, similar to the embodiment depicted in FIG. 3, driving elements 236 are mounted in such away that they are driven in opposite directions, causing rear arms 212 to rotate in opposite directions. As depicted in FIGS. 4 and 5, roller elements 244 and points of fastening of driving elements 236 to driving segments 238 for each driving element 236 may be positioned at a different height along the vertical, or z-axis such that each driving element 236 operates on a different plane from one another.

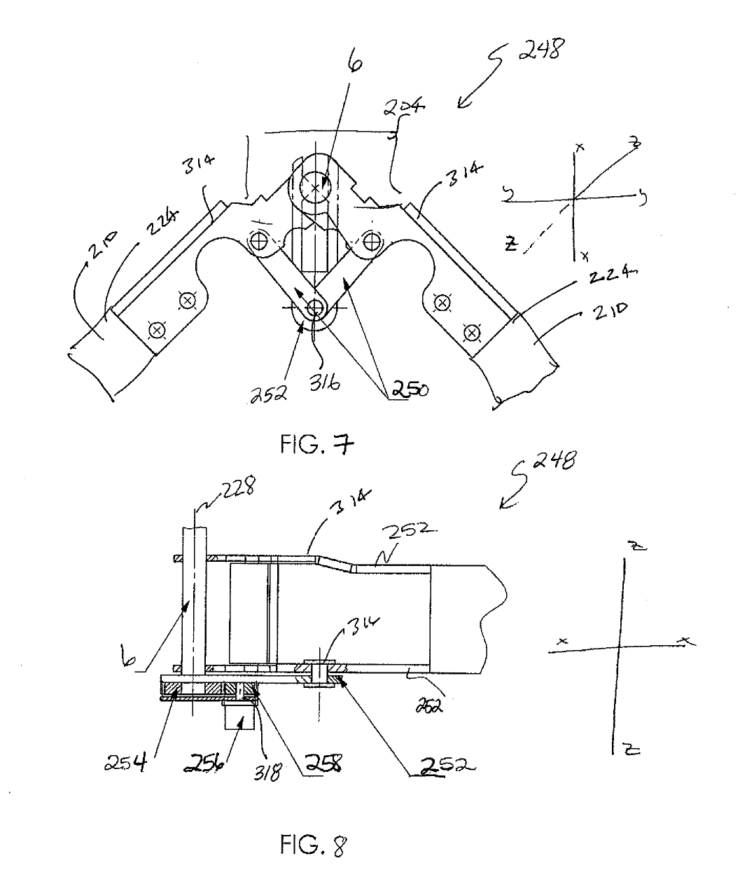

In yet another embodiment illustrated in FIG. 6, driving system 232 comprises driving elements 236 that are toothed bars directly engaged with toothed driving segments 238. Motor 234 rotates shaft 239 with opposite-handed screw threads 240, 240a, such that each screw cap 242, 242a, fixedly joined to toothed element 236 moves along the y-axis in a direction opposite from the other screw cap 242, 242a, and toothed element 236. These toothed elements 236 can be set in a guide 246. Each toothed element 236 is in cooperation with a toothed driving segment 238, which rotates about vertical axis 222 as toothed element 236 moves along the y axis. In response, each rear arm 212 hingedly joined to each driving segment also rotates about vertical axis 222, causing movement of arm 200 along the x axis toward and away from a mounting surface.

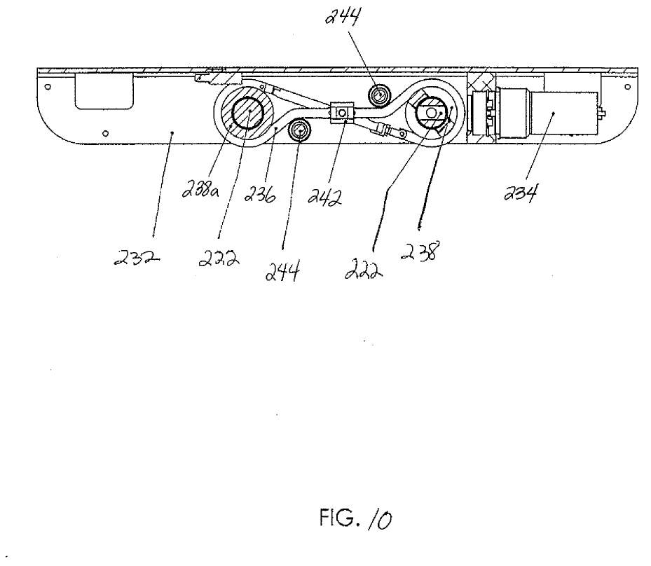

In yet another embodiment, illustrated in FIGS. 9 and 10, driving system 232 comprises a single screw 240 and a single driving element 236, such as a chain, wire, or belt that is generally configured in a figure-eight pathway and in cooperation with driving segments 238. Motor 234 rotates screw 240 moving screw cap 242 along laterally along the y-axis. Screw cap 242 is fixed to driving element 236 in the overlap location of driving element 236. One loop of the figure-eight contacts a portion of first driving segment 238a operably coupled to a first rear arm 212a, while the other loop of the figure-eight wraps contacts a portion of second driving segment 238b operably coupled to a second rear arm 212b, causing the rear arms to rotate about vertical axes 222a and 222b respectively. Because of the figure-eight pathway of driving element 236, first driving segment 238a rotates in a direction opposite second driving segment 238b, causing rear arms 212 to rotate in opposite direction so that arm assembly 208 extends to and from the supporting surface, as described above.

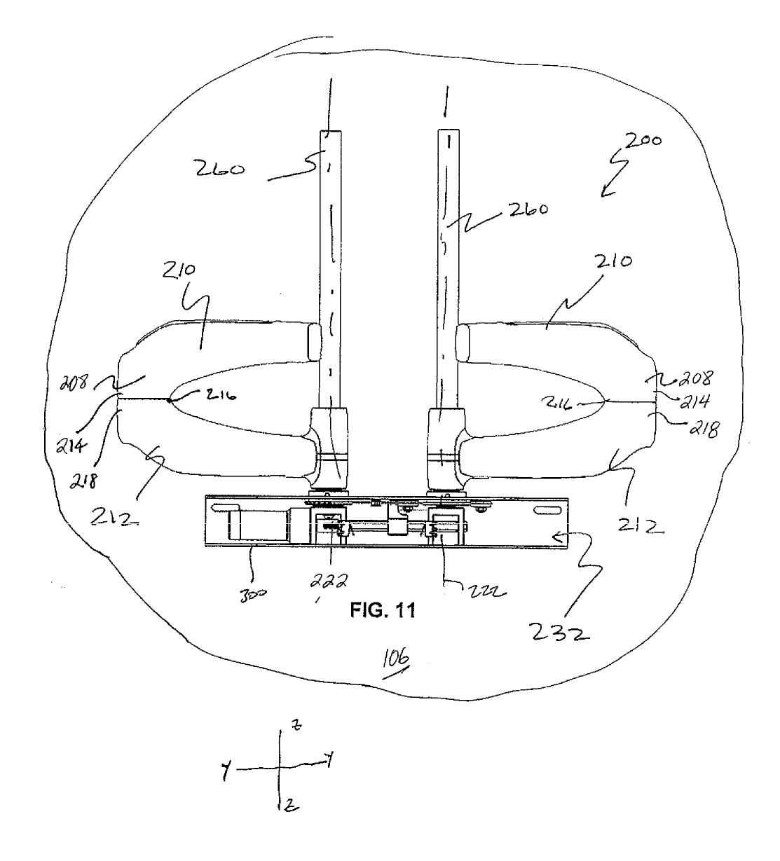

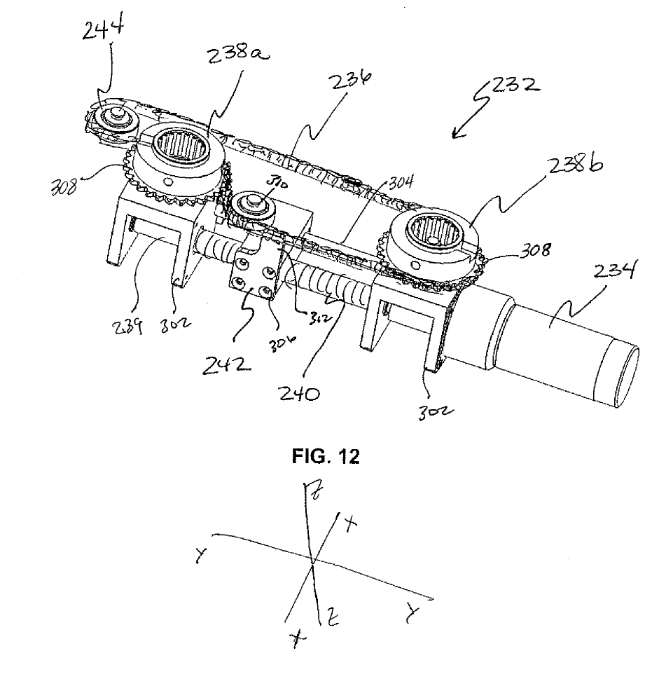

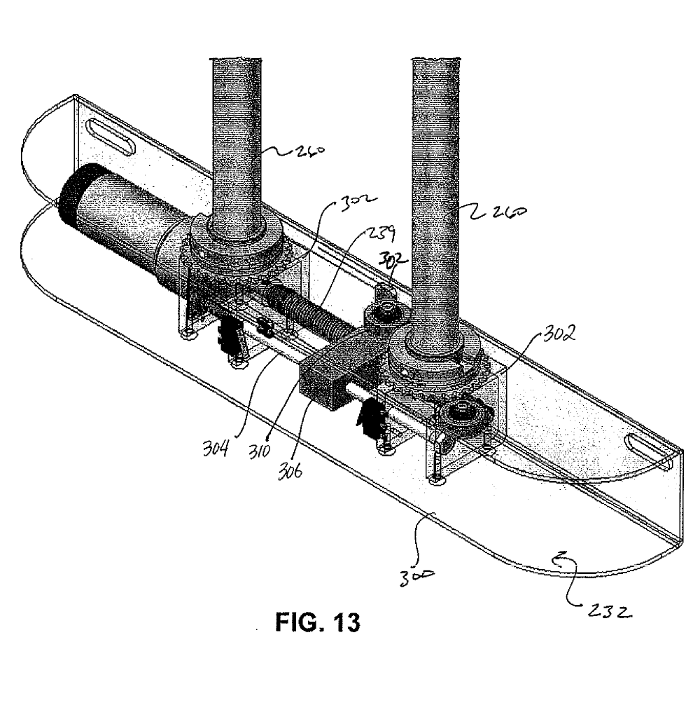

In an alternative embodiment of the invention, referring now to FIGS. 11 and 12, a dual mount arm assembly 200 generally includes driving assembly 232, articulating arm assemblies 208, and uprights 260. Each of articulating arm assemblies 208 includes front arm 210 and rear arm 212. A first end 214 of each front arm 210 is joined by a hinge 216 to a first end 218 of a rear arm 212 such that each front arm 210 and rear arm 212 are rotatable about a substantially vertical axis extending through hinge 216. Front arms 210 and rear arms 212 form a parallelogram. Each rear arm 212 is rotatably mounted on one of uprights 260 so that rear arm 212 is rotatable about vertical axis 222. In some embodiments of the invention, rear arms 212 can articulate by automated drive means along the z-axis up and down uprights 260 for displacement in a vertical direction along fixed structure 106.

Driving assembly 232 generally includes housing 300, upright pillow blocks 302, guide 304, and carriage 306 with screw cap 242. Each of upright pillow blocks 302 is fixed in housing 300, Motor 234 is mounted to one of upright pillow blocks 302 and is coupled to shaft 239. Shaft 239 is rotatably mounted in bearings in each of upright pillow blocks 302 and has screw 240 on an outer surface thereof. Screw cap 242 of carriage 306 is threadedly engaged with screw 240 so that carriage 306 translates laterally, the direction of translation depending on the direction of rotation of shaft 239. Each of uprights 260 is received on one of upright pillow blocks 302. Each of driving segments 238a, 238b, is rotatably received on one of uprights 260 and is fixed to one of rear arms 212. Driving element 236, which in the depicted embodiment is a chain, such as a bicycle-type chain, but in other embodiments may be a wire, cable, belt or similar flexible connection element, is engaged with sprocket portion 308 of each of driving segments 238a, 238d and around roller element 244 and carriage roller 310. Driving element 236 is fixed to tab 312 of carriage 306.

In operation, motor 234 rotates shaft 239 causing carriage 306 to translate. Carriage 306 pulls driving element 236 around roller element 244. The engagement of driving element with sprocket portions 308 of driving segments 238a, 238b, causes driving segments 238a, 238b, and rear arms 212 coupled thereto, to rotate about uprights 260, thereby resulting in the translation of articulating arm assemblies 208 outwardly and inwardly relative to fixed structure 302.

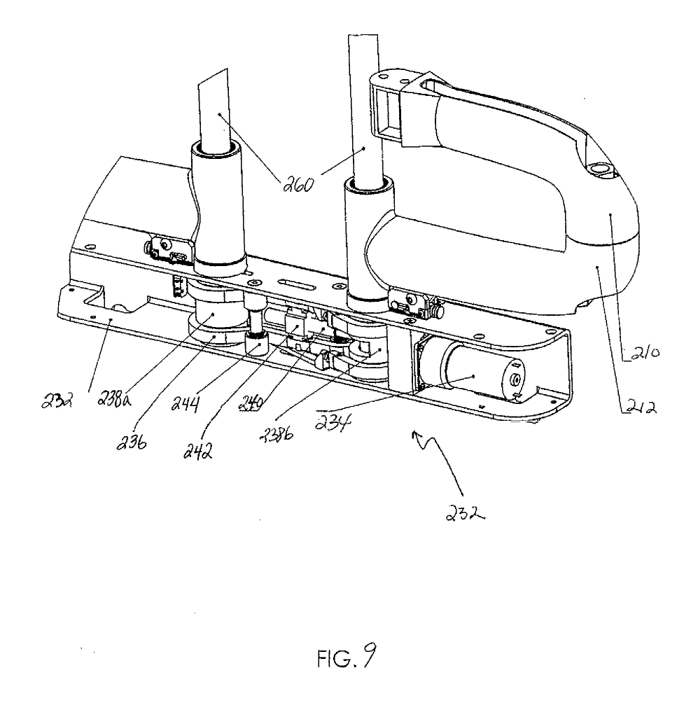

Arm 200 assembly in all the depicted embodiments further comprises an arm synchronizing unit 248, depicted in FIGS. 7 and 8. Arm synchronizing unit 248 generally includes two links 250 and fork 252. Each of front arms 210 has a coupler 314 secured towards end 224. Couplers 314 are pivotally coupled together with pivot pin 6. One end of each link 250 is secured to one of couplers 314 and the links are pivotally coupled to each other with pivot pin 316. Pivot pin 6 is received in the furcation of fork 252. As arms 212 and 210 are shifted by driving assembly 232, synchronizing unit 248 ensures that the resulting translation of a screen interface 104 attached to couplers 314 and an attached electronic display 400 (such as an LCD or plasma display as is known in the art), is directly toward and away from the fixed structure 106 without any lateral component.

In some embodiments, provision may be made for selective automated rotation of a screen interface 204 about a substantially vertical axis. In these embodiments, a motor 256 is mounted to display interface 204. Gear 258 is fixed on shaft 318 of motor 256 and gear 254 is fixed on pivot pin 6. Gear 258 is meshed with gear 254 so that as shaft 318 of motor 256 rotates, gear 258 rotates, causing gear 254 to rotate in toothed cooperation. In response, pivot pin 6 rotates, pivoting screen interface 204 about vertical axis 228.

As described above, the linear movement of driving elements 236 by movement of screw caps 242 along the y axis, causes rotation of the cooperating driving segments 238 and rotation of rear arms 212, resulting in the inner and outer extension of the pantograph unit for revealing or hiding the mounted display screen (not shown).

During outer extension away from the mounting surface, extension of fork 252 also occurs through the scissors folding of couplers 314 and links 250, while the opposite happens during inner extension. Links 250, in combination with fork 252, keep gear 254 and pivot pin 6 in a stable position, keeping screen interface 204 parallel to the mounting surface in which the arms of the pantograph are set, during inner and outer extension.

As described in the single-arm system, a separate head assembly (not shown) can be used for tilting screen interface 104 from a substantially vertical plane.

Arm assemblies 100 and 200 can further comprise a system for remotely actuating the motorized driving systems, such that the automated movement of the arm assemblies, and therefore a display screen, can be controlled remotely. Remote systems known in the art, such as infrared and radio frequency systems, can be used. The automated arm assemblies and methods of automatically articulating a flat panel display screen of the present invention eliminate or reduce the need for manual adjustment of the flat panel display screen.

The embodiments above are intended to be illustrative and not limiting. Additional embodiments are encompassed within the scope of the claims. Although the present invention has been described with reference to particular embodiments, those skilled in the art will recognize that changes may be made in form and detail without departing from the spirit and scope of the invention. For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed is:

1. An automated mount for an electronic display unit, the automated mount comprising:
a support structure including a mounting structure adapted to attach to a fixed structure, and an articulated arm assembly, wherein a first end of the arm assembly is operably coupled to the mounting structure;
a display mounting surface operably coupled with the support structure, wherein the display mounting surface is adapted to receive an electronic display unit thereon; and
a first motorized drive system adapted to drive the articulated arm assembly in a plane substantially perpendicular to the fixed structure, wherein the first motorized drive system includes a motor having a rotatable shaft, and a first driving element operably coupled to the shaft and operably coupled to the articulated arm assembly, wherein the first motorized drive system is adapted to drive the articulated arm assembly and the display mounting surface toward and away from the mounting structure and fixed structure.

2. The automated mount according to claim 1, wherein the articulated arm assembly comprises:
a first front arm; and
a first rear arm, wherein a first end of the first front arm is rotably coupled to a first end of the first rear arm, and wherein a second end of the first front arm is operably coupled to the display mounting surface and a second end of the first rear arm is operably coupled to the mounting structure and the first drive element.

3. The automated mount according to claim 2, wherein the articulated arm assembly comprises a second front arm, and a second rear arm, wherein a first end of the second front arm is rotatably coupled to a first end of the second rear arm, wherein a second end of the second front arm is operably coupled to the display mounting surface along a same axis as the second end of the first front arm, and wherein a second end of the second rear arm is operably coupled to the mounting area and a second drive element, such that the arm assembly forms a pantograph.

4. The automated mount according to claim 3, wherein actuation of the first motorized drive system causes the first drive element and the first rear arm to rotate about a first axis substantially parallel to the fixed surface in a first direction, and the second drive element and the second rear arm to rotate about a second axis substantially parallel to the first axis in a second, opposite direction.

5. The automated mount according to claim 1, further comprising a second motorized drive system fixed to the display mounting surface, wherein the second motorized drive system includes a motor having a rotatable shaft, a first gearwheel fixed to the rotatable shaft, a second gearwheel in cooperation with the first gearwheel and fixed to a pivot pin, the pivot pin fixed to the display mounting surface, such that when the rotatable shaft is rotated, the display mounting surface rotates about an axis coincident with a longitudinal axis of the pivot pin.

6. The automated mount according to claim 2, wherein the first motorized drive system includes:
a first screw fixed to the shaft of the motor,
a first screw cap threadingly engaged with the first screw and fixed to the first driving element, and
a first driving segment fixed to the first rear arm, wherein the first driving segment is operably coupled to the first driving element, such that upon activation of the motor, the first screw rotates, laterally driving the screw cap which in turn drives the first driving element, thereby driving the driving segment to rotate the first rear arm.

7. The automated mount according to claim 6, wherein the first driving element is a chain, a belt, or a wire.

8. The automated mount according to claim 6, wherein the first driving element is a first toothed element, and the first driving segment is a second toothed element in toothed communication with the first toothed element.

9. The automated mount according to claim 6, wherein the first motorized drive system further includes:
a second screw fixed to the shaft of the motor,
a second screw cap threadingly engaged with the second screw and fixed to a second driving element, and
a second driving segment fixed to a second rear arm of the articulating arm assembly, wherein the second driving segment is operably coupled to the second driving element, such that upon activation of the motor, the first screw rotates, laterally driving the first screw cap in a first lateral direction which in turn drives the first driving element, thereby driving the first driving segment causing the first rear arm to rotate in a first direction, and the second screw rotates, laterally driving the second screw cap in a second lateral direction opposite the first lateral direction, which in turn drives the second driving element, thereby driving the second driving segment causing the second rear arm to rotate in a second direction.

10. The automated mount according to claim 3, wherein the first motorized drive system includes:
a first screw fixed to the shaft of the motor,
a first screw cap threadingly engaged with the first screw and operably coupled to the first driving element and the second driving element,
a first driving segment fixed to the first rear arm and operably coupled to the first driving element, and
a second driving segment fixed to the second rear arm and operably coupled to the second driving element, such that upon activation of the motor, the first screw rotates, laterally driving the first screw cap, which in turn drives the first and second driving elements, thereby driving the first driving segment in a first direction causing the first rear arm to rotate in a first rotational direction, and driving the second driving segment in a second direction opposite the first direction causing the second rear arm to rotate in a second rotational direction opposite the first rotational direction.

11. The automated mount according to claim 10, wherein the first driving element is a chain, a belt, or a wire.

12. An automated mount for an electronic display unit, the automated mount comprising:
a support structure including a mounting structure adapted to attach to a fixed structure, and an articulated arm assembly, wherein a first end of the arm assembly is operably coupled to the mounting area;
a display mounting surface operably coupled with the support structure, wherein the display mounting surface is adapted to receive an electronic display unit thereon; and
means for driving the articulated arm assembly and the display mounting surface toward and away from the mounting structure and fixed structure.

13. The automated mount for an electronic display unit according to claim 12, wherein the means for driving the articulated arm assembly and the display mounting surface toward and away from the mounting structure and fixed structure includes a motor having a shaft, and a first driving element operably coupled to the shaft and operably coupled to the articulated arm assembly, such that upon activation of the motor, the shaft drives the first driving element causing a first rear arm of the articulated arm assembly to rotate.

14. The automated mount according to claim 12, further comprising means for rotating the display mounting surface about a vertical axis.

15. The automated mount according to claim 14, wherein the means for rotating the display mounting surface about a vertical axis includes a motor having a rotatable shaft, a first gearwheel fixed to the rotatable shaft, a second gearwheel in cooperation with the first gearwheel and fixed to a pivot pin, the pivot pin fixed to the display mounting surface, such that when the rotatable shaft is rotated, the display mounting surface rotates about an axis coincident with a longitudinal axis of the pivot pin.

16. The automated mount according to claim 15, wherein the means for driving the articulated arm assembly and the display mounting surface toward and away from the mounting structure and fixed structure further includes:
a first screw fixed to the shaft of the motor,
a first screw cap threadingly engaged with the first screw and fixed to the first driving element, and
a first driving segment fixed to the first rear arm, wherein the first driving segment is operably coupled to the first driving element, such that upon activation of the motor, the first screw rotates, laterally driving the screw cap which in turn drives the first driving element, thereby driving the driving segment to rotate the first rear arm.

17. The automated mount according to claim 16, wherein the first driving element is a chain, a belt, or a wire.

18. The automated mount according to claim 16, wherein the first driving element is a first toothed element, and the first driving segment is a second toothed element in toothed communication with the first toothed element.

19. The automated mount according to claim 16, wherein the first motorized drive system further includes:
a second screw fixed to the shaft of the motor,
a second screw cap threadingly engaged with the second screw and fixed to a second driving element, and
a second driving segment fixed to a second rear arm of the articulating arm assembly, wherein the second driving segment is operably coupled to the second driving element, such that upon activation of the motor, the first screw rotates, laterally driving the first screw cap in a first lateral direction which in turn drives the first driving element, thereby driving the first driving segment causing the first rear arm to rotate in a first direction, and the second screw rotates, laterally driving the second screw cap in a second lateral direction opposite the first lateral direction, which in turn drives the second driving element, thereby driving the second driving segment causing the second rear arm to rotate in a second direction.

20. The automated mount according to claim 15, wherein the means for driving the articulated arm assembly and the display mounting surface toward and away from the mounting structure and fixed structure includes:
a first screw fixed to the shaft of the motor,
a first screw cap threadingly engaged with the first screw and operably coupled to the first driving element and the second driving element,
a first driving segment fixed to the first rear arm and operably coupled to the first driving element, and
a second driving segment fixed to the second rear arm and operably coupled to the second driving element, such that upon activation of the motor, the first screw rotates, laterally driving the first screw cap, which in turn drives the first and second driving elements, thereby driving the first driving segment in a first direction causing the first rear arm to rotate in a first rotational direction, and driving the second driving segment in a second direction opposite the first direction causing the second rear arm to rotate in a second rotational direction opposite the first rotational direction.

21. An electronic display system comprising:
an electronic display; and
an automated mount comprising:
a support structure including a mounting structure adapted to attach to a fixed structure, and an articulated arm assembly, wherein a first end of the arm assembly is operably coupled to the mounting structure;
a display mounting surface operably coupled with the support structure, the electronic display received on the display mounting surface; and
a first motorized drive system adapted to drive the articulated arm assembly in a plane substantially perpendicular to the fixed structure, wherein the first motorized drive system includes a motor having a rotatable shaft, and a first driving element operably coupled to the shaft and operably coupled to the articulated arm assembly, wherein the first motorized drive system is adapted to drive the articulated arm assembly and the display mounting surface toward and away from the mounting structure and fixed structure.
